(19) United States
(12) Patent Application Publication
(10) Pub. No.: US 2006/0023740 A1
(43) Pub. Date: Feb. 2, 2006

(54) Rehabilitating a serving area interface cabinet and terminal field for broadband services without service interruption

(75) Inventors: Kermit L. Ross, Frisco, TX (US); Gary L. Gustine, Bonham, TX (US); Hans J. Ziegler, Milwaukee, WI (US)

Correspondence Address: Raffi Gostanian, 1103 Twin Creeks, Allen, TX, 75013, US

(73) Assignee: INFRATEL Communications, LLC

(21) Appl. No.: 11/192,492

(22) Filed: Jul. 29, 2005

Related U.S. Application Data
(60) Provisional application No. 60/592,353, filed on Jul. 29, 2004.
(60) Provisional application No. 60/598,861, filed on Aug. 4, 2004.
(60) Provisional application No. 60/628,433, filed on Nov. 16, 2004.
(60) Provisional application No. 60/662,074, filed on Mar. 15, 2005.
(60) Provisional application No. 60/662,073, filed on Mar. 15, 2005.
(60) Provisional application No. 60/662,072, filed on Mar. 15, 2005.

(51) Int. Cl. H04L 12/66

(52) U.S. Cl. 370/463

(57) ABSTRACT

A system and method for rehabilitating a serving area interface cabinet (SAIC) and deploying broadband services comprises removing an existing SAIC and replacing the existing SAIC with a new combination electronic cabinet and SAIC, wherein the replacing occurs without service interruption.

### CROSS REFERENCE TO RELATED APPLICATIONS

The present invention is related to and claims the benefit of U.S. provisional patent application Ser. No., 60/424,277, entitled TELECOMMUNICATIONS INTERFACE, filed on Nov. 6, 2002 and U.S. non-provisional patent application Ser. No. 10/631,096, entitled TELECOMMUNICATIONS INTERFACE, filed on Jul. 31, 2003, assigned to the assignee of the present invention, the entire contents of each of which are incorporated by reference as if produced in their entirety herein. The present invention is further related to and claims the benefit of U.S. provisional patent application Ser. No. 60/592,353 entitled REHABILATATING A SERVING AREA INTERFACE CABINET AND TERMINAL FIELD WITHOUT SERVICE INTERRUPTION, filed Jul. 29, 2004, U.S. non-provisional patent application Ser. No. 11/005,274 entitled REMOTE POWER NODE, filed Dec. 6, 2004, U.S. provisional patent application Ser. No. 60/598,861 entitled EXPRESS POWER LOAD CENTER, filed Aug. 4, 2004, U.S. non-provisional patent application Ser. No. 11/021,883 entitled EMBEDDED HEAT EXCHANGER, filed Dec. 23, 2004, U.S. provisional patent application Ser. No. 60/628,433 entitled TELECOMMUNICATIONS INTERFACE ENHANCEMENTS, filed Nov. 16, 2004, U.S. provisional patent application Ser. No. 60/662,074, entitled DSLAM ENCLOSURE, filed Mar. 15, 2005, U.S. provisional patent application Ser. No. 60/662,073, entitled FTTC DSLAM OVERLAY, filed Mar. 15, 2005, and U.S. provisional patent application Ser. No. 60/662,072, entitled ENCLOSURE HOUSING MULTIPLE DSLAMs, filed Mar. 15, 2005, assigned to the assignee of the present invention, the entire contents of each of which are incorporated by reference as if produced in their entirety herein.

### FIELD OF THE INVENTION

The present invention is related to a serving area interface cabinet (SAIC) and, more specifically, to rehabilitating an SAIC and terminal field with a new integrated electronic cabinet and SAIC without service interruption. Such a cabinet may include power, fiber, wireless, and other equipment in support of broadband services.

### BACKGROUND OF THE INVENTION

Within a Central Office (CO), cables from switching and transmission equipment lead to a main distributing frame (MDF). The MDF is a large wire cross-connect frame that permits any subscriber line to be connected to any port of any CO equipment. Cables leaving the CO are normally contained in underground conduits with up to 3,600 wire pairs per cable—called feeder cables—which extend from the CO to a wiring junction and interconnection point, known as a serving area interface (SAI). The SAI contains a small wire-jumper panel that permits the feeder cable pairs to be connected to any of several distribution cables.

Deploying broadband transmission electronics, such as DSLAMs or Broadband Loop Carriers, to an existing telecommunication pad mounted SAI site may include providing broadband by rehabilitating existing SAI sites which includes replacing the cabinet shell as well as the terminal field, and utilizing termination and cross-connect blocks which are rated for the particular transmission rates of the application. The rehabilitation of the site is performed without interruption of service. As more bandwidth and “Triple Play” (voice, data and video) services are deployed, the components which make up the wiring and connecting of these services may need to be upgraded. In effect, high bandwidth components which are rated at Category (CAT) 5 or above may need to be utilized. Although the SAIs are a natural place to locate the DSLAM electronics, the existing terminal block fields in these cabinets, such as binding posts, may not pass the necessary bandwidth requirements. In addition, not having utilized tightly twisted and/or shielded block stubs and tightly twisted and/or shielded cross-connect jumpers may not make the wiring scheme capable of supporting high bandwidth services. In addition, cross-connect block fields may have been installed past their 25 year anticipated life. In these cases, retrofitting the site may not be possible and the entire cross-connect field may need to be replaced, not just the cabinet shell. In either case, the present invention provides a solution focusing on the rehabilitation of an SAIC. Since a DSLAM is one of the predominant electronics used for broadband deployment, references herein to broadband electronics or transmission electronics shall be termed DSLAMs.

Because of the bandwidth constraints of copper cable as a function of cable length, telephone companies have been deploying optical fiber closer and closer to end users. The SAI is a perfect place to terminate this fiber cable and when coupled with the ability to locate DSLAMs, provides for a manner in which to reclaim and use the copper pairs to the end users and preclude the exorbitant costs associated with bringing fiber all the way to the “home.”

### SUMMARY OF THE INVENTION

The present invention discloses rehabilitating an SAIC and terminal field with a combined electronic cabinet and SAIC without service interruption. In one embodiment, a method for rehabilitating an SAIC comprises removing an existing SAIC and replacing the existing SAIC with a new combination cabinet. This new cabinet, in one compartment, houses the new SAIC and DSLAM IN and OUT blocks and in other compartments, houses DSLAMs, protection, power, backhaul equipment and such other equipment as may be necessary for broadband service delivery. This rehabilitation is accomplished without service interruption.

In one embodiment, a method for rehabilitating an SAIC comprises removing an existing SAIC, and replacing the existing SAIC with a new combination electronic cabinet and SAIC wherein the replacing occurs without service interruption.

In another embodiment, a method for rehabilitating an SAIC comprises surveying a cross-connect cabinet to be rehabilitated to determine a pair count and jumper assignments, replicating existing terminal block jumper assignments either at a location distant from the cross-connect cabinet or on site, removing a housing shell of the cross-connect cabinet while leaving an existing terminal field intact and operational, terminating appropriate connection interfaces on ends of stubs of a new terminal field into the appropriate feeder and distribution pairs of at least one existing cable, removing the existing terminal field once all connections are made and verified, and installing a new combination cross-connect and electronic cabinet.

In a further embodiment, a SAIC comprises an existing cabinet housing having an intact and operational terminal field and existing cables at a first phase; and a combined SAIC and electronic cabinet including a new terminal field with stubs at a second phase, wherein customer service is not interrupted between the first phase and the second phase.

In yet another embodiment, a method for rehabilitating an SAIC comprises wholly or partially replacing an existing SAIC with a new electronic cabinet and SAIC, wherein the replacing includes replacing most or all feeder and distribution blocks, and, wherein the replacing provides high-bandwidth services via high bandwidth components and occurs without service interruption.

### BRIEF DESCRIPTION OF THE DRAWINGS

FIG. 1 depicts an 1800 pair new cross connect and electronic cabinet with the required high bandwidth connecting blocks according to a preferred embodiment of the present invention; and

FIG. 2 depicts an existing 1800 pair cross connect cabinet with a binding post frame which will be replaced according to a preferred embodiment of the present invention.

### DETAILED DESCRIPTION OF THE INVENTION

The present invention discloses an apparatus and method of completely removing an existing cross-connect cabinet including the existing feeder and distribution terminal field(s) and replacing the existing cabinet with a multiple compartment cabinet as described in patent application Ser. Nos. 60/424,277 and 10/631,096 entitled TELECOMMUNICATIONS INTERFACE. For example, these patent applications describe, among other elements, a method of rehabilitating in which most or all feeder and distribution blocks will be replaced at the time the cabinet is wholly or partially replaced and DSL equipment is added. The replacement occurs without interrupting the service to existing customers. It is important to note that the terminal blocks, stubs and cross-connect wires associated with the new cabinet can be high bandwidth rated, such as CAT 5 or better, depending on the transmission requirements.

Deploying DSLAMs to an existing telecommunication pad mounted SAIC site may include providing broadband services by retrofitting existing SAIC sites. The present invention includes providing broadband services by rehabilitating existing SAIC sites which includes replacing the cabinet shell as well as the terminal field, and utilizing termination and cross-connect blocks which are high bandwidth rated. The rehabilitation of the site is performed without interruption of service. As more bandwidth and “Triple Play” (voice, data and video) services are deployed, the components which make up the wiring and connecting of these services may need to be upgraded depending on the required transmission rates. In effect, high bandwidth components which are rated at CAT 5 or above may need to be utilized.

As telecommunications companies move fiber closer to their customers, SAICs have become a more convenient location for DSLAM electronics. However, the existing terminal block fields in these cabinets, such as older binding posts, may not pass current requirements or may have outlived their useful life. In addition, the lack of tightly twisted and/or shielded block stubs or tightly twisted and/or shielded cross-connect jumpers may not make the wiring scheme capable of transmitting some of the higher transmission speeds or passing the more stringent electromagnetic interference requirements such as cross-talk. In these cases, retrofitting the site may not work and the entire cross-connect field may need to be replaced, not just the cabinet shell.

The present invention comprises a method for transforming the existing cabinet housing (shell) having an intact and operational terminal field and existing cables into a combined SAIC and electronic cabinet with new terminal field with stubs without interrupting customer service.

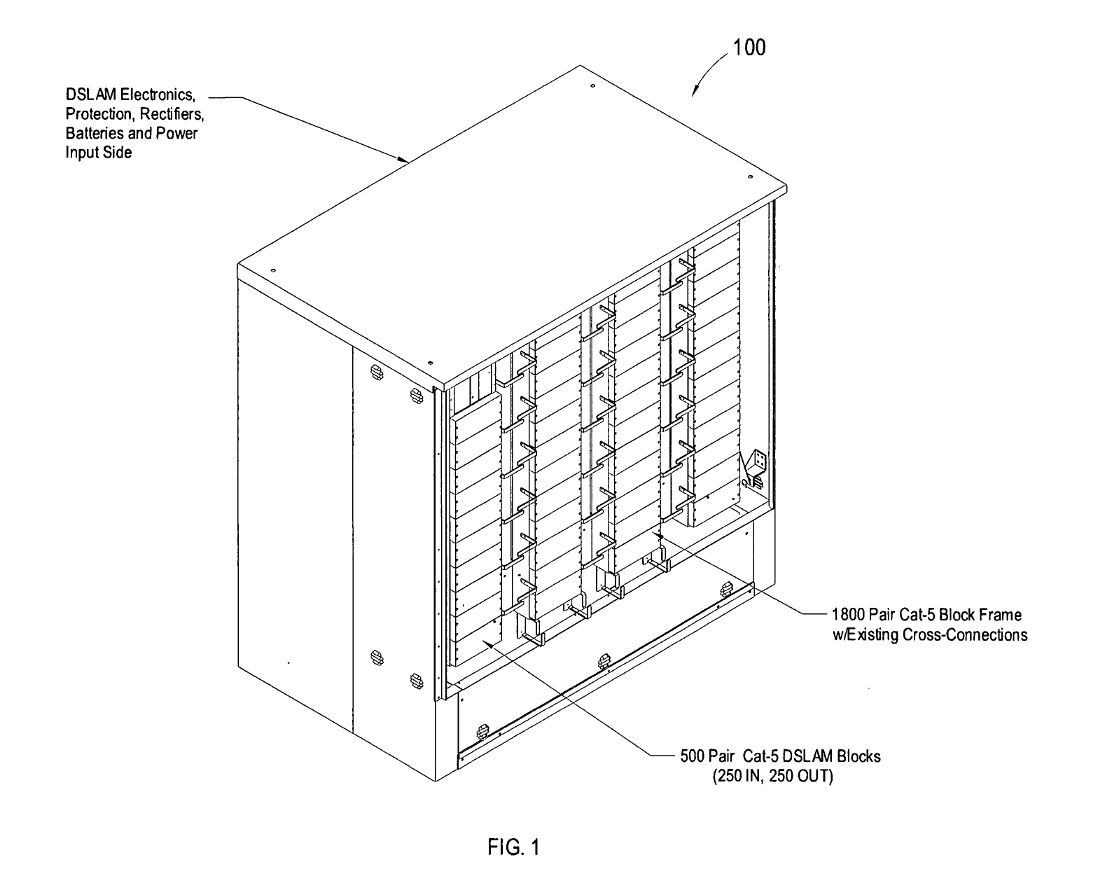

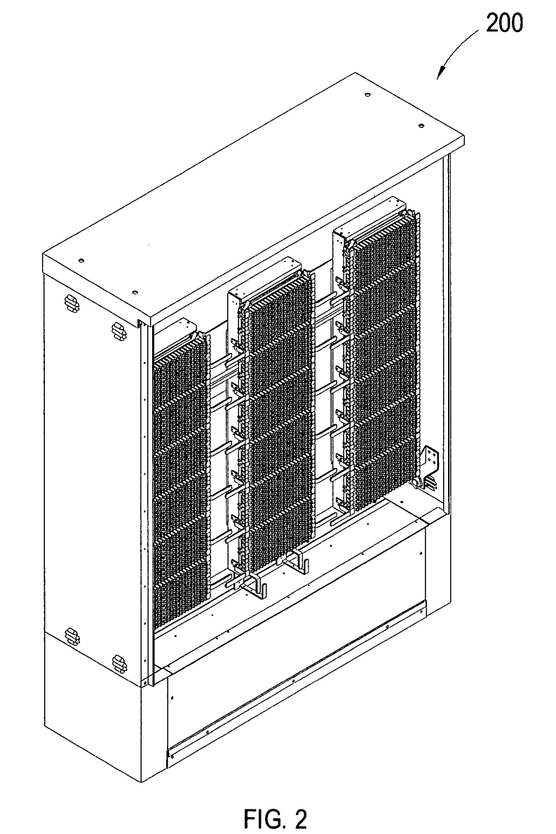

Referring now to the Figures, FIG. 1 depicts a new 1800 pair combination cross connect and electronic cabinet 100 with a high bandwidth connecting block which may be CAT5 or better according to a preferred embodiment of the present invention; and FIG. 2 depicts an existing 1800 pair cross connect cabinet 200 with a binding post frame according to a preferred embodiment of the present invention.

More specifically, the present invention further comprises a method of:

(1) Surveying the cross-connect cabinet to be rehabilitated to determine the pair count and jumper assignments. This may be established, for example, via a computer application for the pre-survey. By using the plant assignment records as a basis, this information can then be loaded into a portable computing device and verified in the field. It also has the corollary effect of purifying the Telco's records.

(2) Replicating the existing Terminal Block jumper assignments at the factory, for example, on the new Terminal Blocks that meet high transmission requirements, such as CAT 5 and beyond. These blocks may use tightly twisted and/or shielded stubs terminated with the appropriate connector interfaces along with tightly twisted and/or shielded single or multiple pair cross-connect wire. The wiring list developed above, for example, could drive the factory processes. This will improve quality as well, since it is possible to ring out each pair from the half-tap module to the feeder/distribution block. The DSLAM IN and DSLAM OUT blocks may utilize a variety of rated components depending on the transmission rates and cross-talk requirements. Further, the DSLAM IN and DSLAM OUT blocks may have integral individual or gang-type plug-in protection along with standard cross-connect capability.

(3) Carefully removing the existing cabinet housing (shell) while leaving the existing terminal field intact and operational.

(4) Terminating appropriate connection interfaces on the ends of the stubs of the new terminal field into the appropriate feeder and distribution pairs of the existing cable(s).

(5) Cutting out the old terminal field (still active) once all connections are made and verified, wherein the cutting is performed according to telephone company practices so as not to interfere with operating circuits. The new cabinet is then installed accepting the new terminal field and either attached to the existing pad bolt hole pattern, or using a custom fabricated adapter plate, or to newly installed bolt inserts.

(6) Covering and segmenting “Jumper Troughs” to reduce electromagnetic radiation leakage or cross interference after DSLAM circuits have been activated.

The embodiments described above are only exemplary. Even though several characteristics and advantages of the present invention have been set forth in the foregoing description together with details of the method of the invention, the disclosure is illustrative only and changes may be made within the principles of the invention to the full extent indicated by the broad general meaning of the terms used in the attached claims.

What is claimed is:

1. A method of rehabilitating a serving area interface cabinet (SAIC), comprising:
surveying a cross-connect cabinet to be rehabilitated to determine a pair count and jumper assignments;
replicating existing terminal block jumper assignments either at a location distant from the cross-connect cabinet or on site;
removing a housing shell of the cross-connect cabinet while leaving an existing terminal field intact and operational;
terminating appropriate connection interfaces on ends of stubs of a new terminal field into the appropriate feeder and distribution pairs of existing cable(s);
removing the existing terminal field once all connections are made and verified; and
installing a new combination cross-connect and electronic cabinet.

2. The method of claim 1, further comprising using a computer application to prepare a pre-survey prior to surveying the cross-connect cabinet to be rehabilitated.

3. The method of claim 2, further comprising using plant assignment records as a basis for the pre-survey.

4. The method of claim 2, further comprising loading the pre-survey information into a portable computer device.

5. The method of claim 4, wherein the portable computer device may be a laptop.

6. The method of claim 4, further comprising verifying the pre-survey information in a remote location.

7. The method of claim 6, further comprising purifying a telephone company's records using the pre-survey.

8. The method of claim 1 further comprising replicating the existing terminal block jumper assignments on new terminal blocks that meet required transmission speed and cross-talk requirements.

9. The method of claim 8, wherein the new terminal blocks may use tightly twisted and/or shielded stubs terminated with appropriate connector interfaces along with tightly twisted and/or shielded single or multiple pair cross-connect wire.

10. The method of claim 8, further comprising using a wiring list to drive factory or field processes.

11. The method of claim 8, wherein the new terminal blocks comprise DSLAM IN and DSLAM OUT blocks that may have high bandwidth components.

12. The method of claim 1, wherein removing the existing terminal field is performed so as not to interfere with operating circuits.

13. The method of claim 1, further comprising installing a new cabinet adapted to accept the new terminal field and which contains DSLAMs, line protection, power protection, electronic power source, thermal control mechanisms, and such other equipment as necessary to support copper-based broadband services.

14. The method of claim 1, further comprising installing a new cabinet adapted to accept the new terminal field and which contains DSLAMs, line protection, power protection, electronic power source, fiber optic transmission equipment, thermal control mechanisms, and such other equipment as necessary to support fiber-based broadband services.

15. The method of claim 1, further comprising installing a new cabinet adapted to accept the new terminal field and which contains DSLAMs, line protection, power protection, electronic power source, thermal control mechanisms, and such other equipment as necessary to support wireless-broadband services.

16. The method of claim 13, further comprising attaching the new cabinet to an existing pad bolt hole pattern.

17. The method of claim 13, further comprising attaching the new cabinet using a custom fabricated adapter plate.

18. The method of claim 13, further comprising attaching the new cabinet to newly installed bolt inserts.

19. The method of claim 1, further comprising covering jumper troughs to reduce radiation leakage, both EMI and RFI, or cross interference after new circuits have been activated.

20. The method of claim 19, wherein the new circuits comprise DSLAM circuits.

21. The method of claim 11 where the DSLAM IN and the DSLAM OUT blocks may have integral individual or gang-type plug-in protection along with standard cross-connect capability.

22. A method for rehabilitating a serving area interface cabinet (SAIC), comprising:
removing an existing SAIC; and
replacing the existing SAIC with a new combination electronic cabinet and SAIC wherein the replacing occurs without service interruption.

23. The method of claim 22, further comprising replacing some or all existing feeders and some or all distribution terminal fields.

24. The method of claim 22, wherein the new cabinet is a multiple compartment cabinet.

25. The method of claim 23, wherein terminal blocks, stubs and cross-connect wires associated with the new cabinet are rated depending on the transmission and cross-talk requirements.

26. A transitional serving area interface cabinet (SAIC), comprising:
an existing cabinet housing having an intact and operational terminal field and existing cables at a first phase; and
a combined SAIC and electronic cabinet including a new terminal field with stubs at a second phase;
wherein customer service is not interrupted between the first phase and the second phase.

27. A method for rehabilitating a serving area interface cabinet (SAIC), comprising:
wholly or partially replacing an existing SAIC with a new combination electronic cabinet and SAIC;
wherein the replacing includes replacing most or all feeder and distribution blocks; and;
wherein the replacing provides high-bandwidth services via high bandwidth components and occurs without service interruption.
